(19) United States
(12) Patent Application Publication
(10) Pub. No.: US 2026/0334425 A1
(43) Pub. Date: Oct. 29, 2026

(54) CAT LITTER BOX

(71) Applicant: JIANGSU ERLANGSHEN PLASTIC CO., LTD, Yangzhou (CN)

(72) Inventors: Yuan Gong, Yangzhou (CN); Kang Zhao, Yangzhou (CN)

(73) Assignee: JIANGSU ERLANGSHEN PLASTIC CO., LTD, Yangzhou (CN)

(21) Appl. No.: 19/714,709

(22) Filed: Jun. 22, 2026

Related U.S. Application Data
(63) Continuation of application No. PCT/CN2024/083527, filed on Mar. 25, 2024.

(30) Foreign Application Priority Data
Dec. 22, 2023 (CN) 2023235331964

(51) Int. Cl. A01K 1/01

(52) U.S. Cl. CPC A01K 1/0114

(57) ABSTRACT

A cat litter box, which comprises a housing, a litter pan, a waste collection assembly and a packaging assembly. The housing includes an inner shell located above the litter pan, and an outer cover. The waste collection assembly includes a waste receptacle, and a driving assembly connected between the inner shell and the outer cover. Sensing members are arranged on sides of a lower portion of the inner housing, and includes a first sensor and a second sensor. A spacing between the first and second sensors is greater than a width of the waste receptacle. The waste receptacle is driven by the driving assembly to rotate. When the waste receptacle blocks the first sensor or the second sensor, the driving assembly drives the waste receptacle to operate normally, and after a pet enters the litter pan, the pet blocks both the first sensor.

This application is a Continuation of PCT Patent Application No. PCT/CN2024/083527 filed on Mar. 25, 2024, which claims priority of China Patent Application No. 202323533196.4 filed on Dec. 22, 2023. The contents of the above-identified applications are incorporated herein by reference.

### TECHNICAL FIELD

The disclosure relates to the field of pet supplies, in particular to a cat litter box.

### BACKGROUND

Pets serve as human companions and are a source of happiness and healthy living for people. Pet raising helps people live healthier and more fulfilling lives. additionally, it benefits the human heart and reduces blood pressure and blood lipid levels. Common cat litter boxes are not equipped with sensors for detecting pets. When a pet enters the litter box to defecate and the driving assembly of the waste collection assembly actuates the rake sieve screen to remove pet excreta inside the box, the defecating pet tends to get startled. A startled pet may scurry frantically within the cat litter box, potentially causing bodily harm to the pet itself.

Accordingly, it is necessary to provide a cat litter box to solve the above technical problems.

### SUMMARY

This application provides a cat litter box, which addresses the problem that in the existing art, cat litter boxes lack sensors for detecting pets, and when a pet enters the litter pan to defecate, the drive assembly of the waste collection assembly drives a sieve screen to clean pet waste within the litter pan, the pet that is in the process of defecating is susceptible to being startled, a startled pet tends to scramble about indiscriminately within the cat litter box, which may readily cause injury to the pet.

### Technical Solution

In order to solve the aforementioned technical problems, the technical solution of this application is as follows: a cat litter box including a housing, a litter pan, a packaging assembly. The litter pan is installed inside the housing to receive pet waste. The waste collection assembly is located within the housing and above the litter pan to collect pet waste from the litter pan. The packaging assembly is arranged on one side of the litter pan, and configured to receive and package the pet waste. Wherein the housing includes an inner shell arranged above the litter pan, and an outer cover. The waste collection assembly includes a waste receptacle mounted to the inner side of the inner shell, and a drive assembly connected between the inner shell and the outer cover to drive the waste receptacle to rotate. Sensing members are arranged on both sides of a lower portion of the inner shell, the sensing members includes a first sensor and a second sensor, the waste receptacle is configured to alternately obstruct either the first sensor or the second sensor to trigger corresponding sensing signals, a spacing between the first sensor and the second sensor is larger than a width of the waste receptacle.

In this application, the waste receptacle comprises two swing arms symmetrically mounted to an inner wall of the inner shell, and a sieve screen; two ends of the sieve screen are respectively connected to the swing arms; the swing arms are configured to alternately obstruct the first sensor or the second sensor, and a width of each swing arm is smaller than the spacing between the first sensor and the second senso.

In this application, the drive assembly comprises a motor connected to a bottom of the inner shell and adjacent to the packaging assembly, and a rotating rod horizontally connected to the motor and meshed therewith, two ends of the rotating rod are drivingly coupled to the corresponding swing arms.

In this application, the drive assembly further comprises a synchronous belt, two first synchronous wheels, and two second synchronous wheels; the two first synchronous wheels are connected to two ends of the rotating rod respectively; the two seconds synchronous wheels are separately fixed on an end of each swing arm away from the sieve screen, and extend outside the inner shell; the two first synchronous wheels and the two second synchronous wheels are engaged with the synchronous belt.

In this application, the sensing members are a plurality of sensors that are arranged on both sides of each swing arm.

In this application, the swing arm defines a through slot arranged inside the swing arm and extending along a longitudinal direction of the swing arm and further defines a mounting slot formed on one side of the swing arm and communicating with the through slot; a limiting member is located within the mounting slot and configured to limit movements of the sieve screen; mounting brackets are arranged at opposite ends of the sieve screen, each mounting bracket extends into the through slot and is positioned behind the limiting member.

In this application, a fixing slot is further defined on one side of the swing arm, and the fixing slot is in communication with the mounting slot; the limiting member comprises a fixing plate, rotating shafts positioned on opposite sides of the fixing plate, a button arranged at a top end of the fixing plate, an elastic member housing inside the fixing slot and located below the button, and a blocking member arranged below another end of the fixing plate and configured to coupled with the mounting bracket.

In this application, a fixing base is arranged on an outer wall of the inner shell, and configured to secure the motor.

In this application, protective casing are disposed on opposite sides of the inner shell, and the second synchronous wheels are accommodated within the inner shell.

In this application, an inclined surface is formed on one side of the blocking member.

### Beneficial Effects

Compared with the prior art, the present utility model has the following beneficial effects: in the cat litter box of the present application, the drive assembly drives the waste collection assembly to rotate. The drive assembly operates normally when the waste collection assembly obstructs either the first sensor or the second sensor. When a pet enters the litter pan, the pet with a relatively large body size will simultaneously block both the first sensor and the second sensor. The drive assembly deactivates immediately to prevent the moving waste collection assembly from startling the pet, thereby effectively improving the defecation safety of the pet inside the litter pan.

### BRIEF DESCRIPTION OF THE DRAWINGS

In order to more clearly illustrate the embodiments of this application or the technical solutions in the existing art, a brief introduction of the drawings required for use in the embodiments is provided hereinafter. The drawings described hereinafter are merely drawings corresponding to partial embodiments of this application.

FIG. 1 is a perspective view of a cat litter box according to this application.

FIG. 2 is a top plan view of the cat litter box according to this application.

FIG. 3 is a cross-sectional view taken along section line A-A in FIG. 2.

FIG. 4 is a perspective view of the inner shell of the cat litter box according to this application.

FIG. 5 is a perspective view of the waste collection assembly of the cat litter box according to this application.

FIG. 6 is a top plan view of the swing arm of the cat litter box according to this application.

FIG. 7 is a cross-sectional view taken along section line B-B in FIG. 6.

### DETAILED DESCRIPTION OF THE EMBODIMENTS

In order to render the objectives, technical solutions, and advantages of the embodiments of the present disclosure more apparent, the technical solutions of the embodiments of the present disclosure will be clearly and completely described hereinafter with reference to the accompanying drawings of the embodiments of the present disclosure. It is evident that the described embodiments are a portion of the embodiments of the present disclosure, rather than the entirety of the embodiments. Based on the described embodiments of the present disclosure, all other embodiments obtained by persons of ordinary skill in the art without creative effort fall within the scope of protection of the present disclosure.

Unless otherwise defined, technical or scientific terms used herein shall have the ordinary meaning as understood by persons of ordinary skill in the art to which the present disclosure pertains.

The terms “first,” “second,” and similar expressions used in the specification and claims of the present patent application do not denote any order, quantity, or importance, but are merely used to distinguish different components. Words such as “comprising” or “including” indicate that the elements or objects recited before “comprising” or “including” encompass the elements or objects recited after “comprising” or “including” and their equivalents, without excluding other elements or objects. Words such as “connected” or “coupled” are not limited to physical or mechanical connections, but may include electrical connections, whether direct or indirect. “Above,” “below,” “left,” “right,” and similar expressions are used solely to indicate relative positional relationships. When the absolute position of the described object changes, the relative positional relationship may also change accordingly.

The technical solutions of the embodiments of this application will be clearly and completely described hereinafter with reference to the accompanying drawings of the embodiments of this application. It is evident that the described embodiments are merely a portion of the embodiments of this application, rather than the entirety of the embodiments. Based on the embodiments of this application, all other embodiments obtained by persons skilled in the art without creative effort fall within the scope of protection of this application.

The following is a preferred embodiment of a cat litter box provided by this application, capable of solving the aforementioned technical problems.

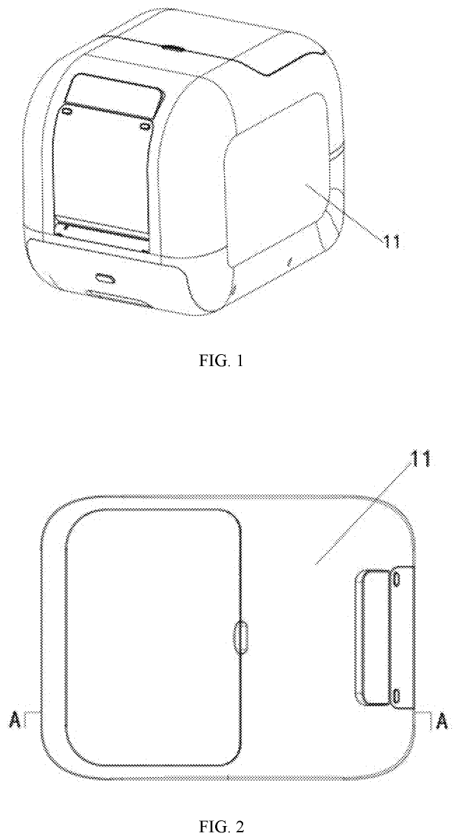

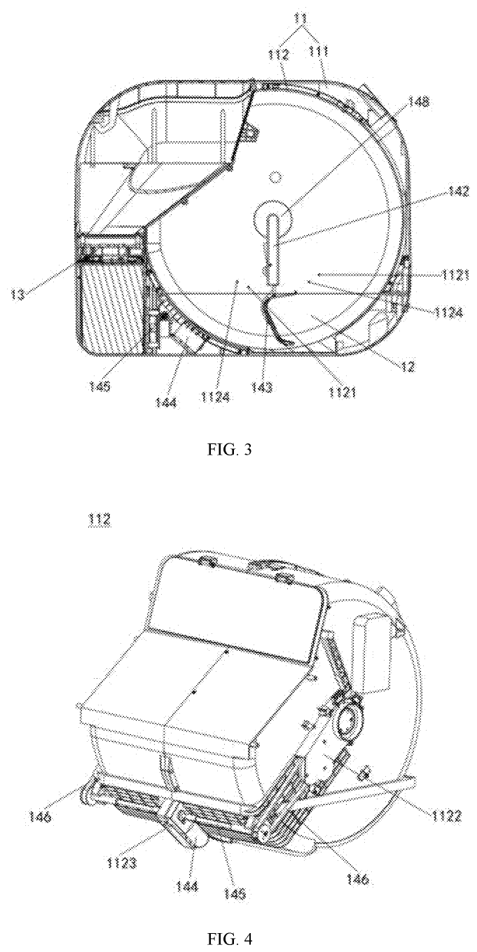

Referring to FIGS. 1, 2 and 3, FIG. 1 illustrates a perspective view of a cat litter box constructed in accordance with an embodiment of this application; FIG. 2 illustrates a top plan view of the cat litter box; and FIG. 3 illustrates a cross-sectional view taken along section line A-A of FIG. 2.

Identical reference numerals are used throughout the drawings to denote identical or structurally similar components, and repeated descriptions of the same components will be omitted for brevity.

The terms such as “first” and “second” adopted in this application are only utilized for distinguishing corresponding components, and are neither intended to indicate a hierarchical relationship nor a fixed sequential order among related structures.

This application provides a cat litter box, including a housing 11, a litter pan 12 located inside the housing 11 to allow pet to defecate, a waste collection assembly 14 located within the housing 11 above the litter pan 12 to collect pet waste from the litter pan 12, and a packaging assembly 13 arranged on one side of the litter pan 12 to receive and package the pet waste. The housing 11 includes an inner shell 112 positioned above the litter pan 12 and an outer cover 111. The waste collection assembly 14 includes a waste receptacle and a drive assembly, two opposite sides of the waste receptacle are symmetrically mounted to an inner wall of the inner shell 112, and the drive assembly is connected between the inner shell 112 and the outer cover 111 to drive the waste receptacle to rotate. sensing members are arranged on two sides of a lower portion of the inner shell 112, the sensing members including a first sensor 1121 and a second sensor 1124. The waste receptacle is configured to obstruct either the first sensor 1121 or the second sensor 1124, such that the corresponding sensor receives a sensing signal. A spacing between the first sensor 1121 and the second sensor 1124 is greater than a width of the waste receptacle. The housing 11 is configured to accommodate the litter pan 12, the waste collection assembly 14 and the packaging assembly 13. The litter pan 12 provides a dedicated area for pets to defecate. The waste collection assembly 14 is configured to collect pet waste from the litter pan 12 and transport the collected waste to the packaging assembly 13 for subsequent treatment. The packaging assembly 13 performs automatic packaging on the pet waste to eliminate manual cleaning operations. The sensing members are configured to detect presence or absence of a pet inside the litter pan 12. The waste receptacle stops rotating when a pet is detected within the litter pan 12, so as to facilitate pet defecation. During waste collection and packaging operations, the drive assembly firstly drives the waste receptacle to rotate inside the inner shell 112. When traveling across the litter pan 12, the waste receptacle drives the pet waste disposed within the litter pan 12 to move. Benefiting from the detection characteristic of the sensing members and the dimensional feature that the width of the waste receptacle is smaller than the spacing between the first sensor 1121 and the second sensor 1124, the drive assembly maintains normal operation when the waste receptacle only obstructs one of the two sensors. When a pet enters the litter pan 12, the relatively large body size of the pet will simultaneously obstruct both the first sensor 1121 and the second sensor 1124. At this moment, the drive assembly deactivates to prevent the operating waste collection assembly 14 from startling the pet, thereby improving the overall safety for pets defecating inside the litter pan 12.

Specifically, the waste receptacle of the waste collection assembly 14 includes two swing arms 142 and a sieve screen 143. The two swing arms 142 are symmetrically mounted to inner walls of the inner shell 112, and opposite ends of the sieve screen 143 are fixedly connected to the corresponding swing arms 142, respectively. The swing arms 142 are configured to alternately obstruct either the first sensor 1121 or the second sensor 1124 to trigger a corresponding sensing signal. A width of each swing arm 142 is less than a spacing defined between the first sensor 1121 and the second sensor 1124. The above dimensional limitation prevents the swing arms 142 from obstructing the two sensors simultaneously during circumferential rotation, effectively eliminating false detections from the sensing members caused by misjudgment.

The drive assembly includes a motor 144 and a rotating rod 145. The motor 144 is arranged at a bottom portion of the inner shell 112 and adjacent to the packaging assembly 13. The rotating rod 145 is horizontally assembled and meshed with the motor 144. Two ends of the rotating rod 145 are drivingly coupled to the swing arms 142. The motor 144 is configured to drive the rotating rod 145 to rotate. Both ends of the rotating rod 145 synchronously drive the swing arms 142 to pivot, so that the swing arms 142 may drive the sieve screen 143 to move and clean the pet waste accumulated inside the litter pan 12.

The drive assembly further includes a synchronous belt 146, two first synchronous wheels 147 respectively attached to two ends of the rotating rod 145, and two second synchronous wheels 148 respectively fixed on one end of each swing arm 142 away from the sieve screen. The two second synchronous wheels 148 extend outside of the inner shell 12, and the two first synchronous wheels and the two second synchronous wheels are engaged with the synchronous belt 146. The first synchronous wheels 147 drive the corresponding second synchronous wheels 148 to rotate via the synchronous belt 146, thereby allowing the symmetrically arranged swing arms 142 to pivot synchronously and preventing the sieve screen 143 from laying at a horizontal position and avoids leakage of pet waste carried on the sieve screen 143.

A plurality of sensing members are provided and arranged on both sides of each swing arm 142. The plurality of sensing members are configured to achieve omnidirectional sensing and real-time monitoring inside the litter pan 12, thereby preventing small-sized pets from defecating within detection blind zones of the sensing members and further enhances overall pet safety.

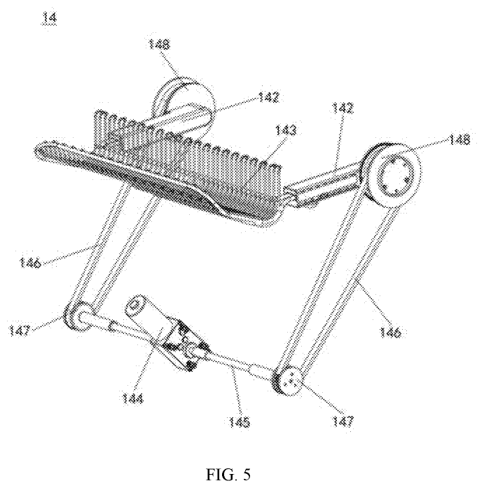

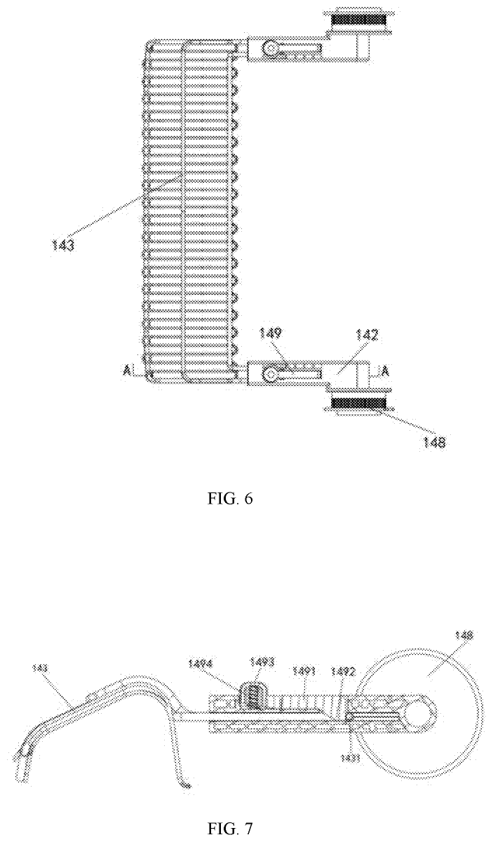

Referring to FIGS. 5, 6 and 7, FIG. 5 is a perspective view illustrating the waste collection assembly of the cat litter box of this application, FIG. 6 is a top plan view of a swing arm 142 of the cat litter box, and FIG. 7 is a cross-sectional view taken along section line B-B of FIG. 6. The swing arm 142 defines a through slot extending longitudinally inside the swing arm 142, a mounting slot formed on one side of the swing arm 142 and communicating with the through slot, and a limiting member 149 assembled within the mounting slot to restrict the sieve screen 143. Opposite ends of the sieve screen 143 are respectively provided with mounting brackets 1431. Each mounting bracket 1431 extends into the through slot and is positioned rearward of the limiting member 149. The through slot is configured to accommodate the mounting brackets 1431, the mounting slot is configured to receive the limiting member 149, and the limiting member 149 is configured to limit movements of the mounting brackets 1431 so as to fixedly mounted the mounting brackets 1431 of the sieve screen 143 to the swing arm 142.

A fixing slot is further defined on one side of the swing arm 142 and communicates with the mounting slot. The limiting member 149 includes a fixing plate 1491, rotating shafts arranged on two sides of the fixing plate 1491, a button 1493 positioned on a top one end of the fixing plate 1491, an elastic element 1494 received within the fixing slot and positioned below the button 1493, and a blocking member 1492 located below the other end of the fixing plate 1491 for clamping the mounting bracket 1431. The fixing slot is adapted to accommodate the elastic element 1494. When the button 1493 is pressed, the button 1493 compresses the elastic element 1494 to cause elastic deformation thereof. The fixing plate 1491 pivots around the rotating shafts, causing the button 1493 to move downward and the blocking member 1492 to move upward so as to create a clearance for the mounting bracket 1431 to be inserted into or withdrawn therefrom. When the button 1493 is released, the elastic element 1494 is freed from compressive force and recovers its original shape to oppositely push the button 1493 upward. The rising button 1493 drives the blocking member 1492 to descend to occlude the through slot, preventing the mounting bracket 1431 from separating from the swing arm 142. In addition, the elastic element 1494 exerts positional limitation on the blocking member 1492 to effectively prohibit the upward movement of the blocking member 1492, so that the mounting bracket 1431 of the sieve screen 143 can be more stably assembled to the swing arm 142.

Referring to FIG. 4, FIG. 4 is a perspective view of the inner shell of the cat litter box according to this application. A fixing base 1123 is located on an outer wall of the inner shell 112, and configured to secure the motor 144 so as to enable the motor 144 to stably drive the rotating rod during operation.
protective casings 1122 are further mounted on two sides of the inner shell 112, and the second synchronous wheels 148 are accommodated inside the corresponding protective casings 1122. Firstly, the protective casings 1122 may prevent foreign matter from entering the drive assembly; secondly, the protective casings 1122 may protect users by avoiding accidental contact of users' fingers or clothes with the second synchronous wheels 148.

An inclined surface is formed on one side of the blocking member 1492. The inclined surface enables the mounting bracket 1431 to easily slide into a rear side of the blocking member 1492. During assembly, the mounting bracket 1431 can be directly installed without pressing the button 1493.

The working principle of the present utility model is described in detail as follows.

When cleaning pet waste, firstly, the motor 144 activates and drives the rotating rod 145 to rotate. The rotation of the rotating rod 145 drives the first synchronous wheels 147 arranged at both ends thereof to rotate. Under the transmission action of the synchronous belt 146, the first synchronous wheels 147 drive the corresponding second synchronous wheels 148 to rotate via the synchronous belt 146. The rotating second synchronous wheels 148 further drive the swing arms 142 to pivot. Since the mounting brackets 1431 of the sieve screen 143 are fixedly assembled inside the swing arms 142, the swing arms 142 drive the sieve screen 143 to move synchronously. With the swing arms 142 serving as the rotation center, the sieve screen 143 cleans pet waste accumulated inside the litter pan 12. During the pivoting process of the swing arms 142, the drive assembly maintains normal operation if the swing arms 142 obstruct either the first sensor 1121 or the second sensor 1124. When a pet enters the litter pan 12 for defecation, the pet with a relatively large body size will simultaneously obstruct both the first sensor 1121 and the second sensor 1124. At this time, the motor 144 stops operating to facilitate pet defecation inside the litter pan 12. Furthermore, the plurality of sensing members are arranged to conduct all-round sensing and real-time monitoring within the litter pan 12, which eliminates detection blind zones for small-sized pets and improves the overall defecation safety of pets.

When the sieve screen 143 is contaminated with pet waste and requires cleaning, the disassembly procedure is performed as follows. The button 1493 is pressed to compress the spring 1494 and trigger elastic deformation. As the button 1493 moves downward, the fixing plate 1491 pivots about the rotating shafts, which causes the blocking member 1492 to move upward. The lifted blocking member 1492 releases the positional constraint on the mounting bracket 1431, so that the mounting bracket 1431 can be withdrawn from the through slot to complete the disassembly of the sieve screen 143. After the button 1493 is released, the spring 1494 is relieved from compressive force and rebounds to its original state, pushing the button 1493 upward and causing the blocking member 1492 to descend back into the through slot. For installation of the mounting bracket 1431, the bracket is inserted into the through slot and pushed toward the blocking member 1492. Benefiting from the inclined surface arranged on the blocking member 1492, the mounting bracket 1431 pushes the blocking member 1492 upward effortlessly and compresses the spring 1494 via the button 1493. Once the mounting bracket 1431 slides past the blocking member 1492, the spring 1494 rebounds again to push the button 1493 upward and lower the blocking member 1492. The blocking member 1492 re-constrains the mounting bracket 1431 to prevent accidental separation and secure the sieve screen 143 steadily to the swing arm 142. The structure for mounting and detaching the sieve screen 143 features simple operation. The sieve screen 143 can be removed independently for separate and comprehensive cleaning, which simplifies daily maintenance and achieves a better cleaning effect.

In conclusion, although this application has been disclosed in accordance with preferred embodiments, the embodiments described above are not intended to limit this application. Those skilled in the art may make various modifications and improvements without departing from the spirit and scope of this application. Therefore, the protection scope of this application shall be subject to the scope defined by the appended claims.

1. A cat litter box, comprising
a housing;
a litter pan, installed inside the housing to receive pet waste;
a waste collection assembly, located within the housing and above the litter pan to collect pet waste from the litter pan; and
a packaging assembly arranged on one side of the litter pan, and configured to receive and package the pet waste;
wherein the housing comprises an inner shell arranged above the litter pan, and an outer cover;
the waste collection assembly comprises a waste receptacle mounted to the inner side of the inner shell, and a drive assembly connected between the inner shell and the outer cover to drive the waste receptacle to rotate; sensing members are arranged on both sides of a lower portion of the inner shell, the sensing members comprise a first sensor and a second sensor, the waste receptacle is configured to alternately obstruct either the first sensor or the second sensor to trigger corresponding sensing signals, a spacing between the first sensor and the second sensor is larger than a width of the waste receptacle.

2. The cat litter box according to claim 1, wherein the waste receptacle is symmetrically mounted to an inner wall of the inner shell by two swing arms, and a sieve screen; two ends of the sieve screen are respectively connected to the swing arms; the swing arms are configured to alternately obstruct the first sensor or the second sensor, and a width of each swing arm is smaller than the spacing between the first sensor and the second sensor.

3. The cat litter box according to claim 2, wherein the drive assembly comprises a motor connected to a bottom of the inner shell and adjacent to the packaging assembly, and a rotating rod horizontally connected to the motor and meshed therewith, two ends of the rotating rod are drivingly coupled to the corresponding swing arms.

4. The cat litter box according to claim 3, wherein the drive assembly further comprises a synchronous belt, two first synchronous wheels, and two second synchronous wheels; the two first synchronous wheels are connected to two ends of the rotating rod respectively; the two second synchronous wheels are separately fixed on an end of each swing arm away from the sieve screen, and extend outside the inner shell; the two first synchronous wheels and the two second synchronous wheels are engaged with the synchronous belt.

5. The cat litter box according to claim 2, wherein the sensing members are a plurality of sensors that are arranged on both sides of the housing.

6. The cat litter box according to claim 2, wherein the swing arm defines a through slot arranged inside the swing arm and extending along a longitudinal direction of the swing arm and further defines a mounting slot formed on one side of the swing arm and communicating with the through slot; a limiting member is located within the mounting slot and configured to limit movements of the sieve screen;
mounting brackets are arranged at opposite ends of the sieve screen, each mounting bracket extends into the through slot and is positioned behind the limiting member.

7. The cat litter box according to claim 6, wherein a fixing slot is further defined on one side of the swing arm, and the fixing slot is in communication with the mounting slot;
the limiting member comprises a fixing plate, rotating shafts positioned on opposite sides of the fixing plate, a button arranged at a top end of the fixing plate, an elastic member housing inside the fixing slot and located below the button, and a blocking member arranged below another end of the fixing plate and configured to coupled with the mounting bracket.

8. The cat litter box according to claim 3, wherein a fixing base is arranged on an outer wall of the inner shell, and configured to secure the motor.

9. The cat litter box according to claim 3, wherein protective casing are arranged on opposite sides of the inner shell, and the second synchronous wheels are accommodated within the inner shell.

10. The cat litter box according to claim 7, wherein an inclined surface is formed on one side of the blocking member.

11. A cat litter box, comprising
a housing;
a litter pan configured to hold litter, installed inside the housing for pet to excrete;
a waste collection assembly, comprising a waste receptacle, and a pair of swing arms configured to pivot the waste receptacle within the housing on two opposite sides, wherein the waste receptacle is rotatable to scoop and collect the pet waste from the litter pan; and
at least one pair of sensing members arranged sequentially at intervals within the housing along a swing direction of the swing arms, such that only one sensor of on a pair of the sensing members is obscured at a time when the waste receptacle rotates;
and the pair of the sensing members are both obscured when a cat enters the housing.

12. The cat litter box according to claim 11, wherein a spacing between the pair of sensing members is larger than a width of each swing arm.

13. The cat litter box according to claim 11, further comprising a packaging assembly arranged on one side of the litter pan, and being configured to receive and package the pet waste.

14. The cat litter box according to claim 13, further comprising a drive assembly including a motor connected to a bottom of an inner shell of the housing and adjacent to the packaging assembly, and a rotating rod horizontally and drivingly coupled to the motor; two ends of the rotating rod are drivingly coupled to the corresponding swing arms.

15. The cat litter box according to claim 14, further comprising a synchronous belt, two first synchronous wheels, and two second synchronous wheels; the two first synchronous wheels being connected to two ends of the rotating rod respectively; the two second synchronous wheels being separately fixed on an end of each swing arm away from the sieve screen, and extending outside the inner shell; the two first synchronous wheels and the two second synchronous wheels being engaged with the synchronous belt.

16. The cat litter box according to claim 15, wherein the at least one sensing members includes a plurality pair of sensing members that are arranged on the opposite sides of the inner shell.

17. The cat litter box according to claim 15, wherein each the swing arm defines a through slot arranged inside the swing arm and extending along a longitudinal direction of the swing arm and further defines a mounting slot formed on one side of the swing arm and communicating with the through slot; a limiting member is located within the mounting slot and configured to limit movements of the sieve screen;
mounting brackets are arranged at opposite ends of the sieve screen, each mounting bracket extends into the through slot and is positioned behind the limiting member.

18. The cat litter box according to claim 17, wherein a fixing slot is further defined on one side of the swing arm, and the fixing slot is in communication with the mounting slot; the limiting member comprises a fixing plate, rotating shafts positioned on opposite sides of the fixing plate, a button arranged at a top end of the fixing plate, an elastic member housing inside the fixing slot and located below the button, and a blocking member arranged below another end of the fixing plate and configured to coupled with the mounting bracket.

19. The cat litter box according to claim 18, wherein a fixing base is arranged on an outer wall of the inner shell, and configured to secure the motor.

20. The cat litter box according to claim 18, wherein the waste receptacle includes a sieve screen, and two sides of the sieve screen are respectively connected to the swing arms.
